(19) United States
(12) Patent Application Publication
(10) Pub. No.: US 2021/0324138 A1
(43) Pub. Date: Oct. 21, 2021

(54) ELECTRICAL-RESISTANCE ADJUSTING AGENT

(71) Applicant: OSAKA SODA CO., LTD.

(72) Inventors: Kazuki UNO, Osaka (JP); Yoritaka YASUDA, Osaka (JP); Naoya YAJIMA, Osaka (JP); Shinichi UDO, Osaka (JP)

(73) Assignee: OSAKA SODA CO., LTD., Osaka (JP)

(21) Appl. No.: 16/490,210

(22) PCT Filed: Mar. 27, 2018
(86) PCT No.: PCT/JP2018/012527

§ 371 Date: Aug. 30, 2019

(30) Foreign Application Priority Data
Mar. 31, 2017 (JP) 2017-072359

(51) Int. Cl. C08G 65/24; C08G 65/08

(52) U.S. Cl. CPC C08G 65/24; C08G 65/08

(57) ABSTRACT

A polyether electrical-resistance adjusting agent of the present invention comprises a polymer that contains 10 to 60 mol % of a structural unit derived from an epihalohydrin (a), 30 to 89 mol % of a structural unit derived from an alkylene oxide (b), and 1 to 15 mol % of a structural unit derived from an ethylenically unsaturated group-containing monomer (c), and that has a weight-average molecular weight of 1,300,000 or less.

### TECHNICAL FIELD

The present invention relates to an electrical-resistance adjusting agent comprising a polyether polymer, an electrical-resistance adjusting agent-containing composition comprising the electrical-resistance adjusting agent, and a molded body thereof.

### BACKGROUND ART

By combining an electrical-resistance adjusting agent with a rubber or a resin, the electrical-resistance adjusting agent is used as parts of various office automation (OA) apparatuses including an image forming apparatus such as an electrophotographic apparatus and an electrostatic recording apparatus. Examples of the parts of OA apparatuses include a conductive roller, which is composed of a core material and a conductive elastic body such as a semiconductive rubber material.

Usually, a conductive carbon black is used as the electrical-resistance adjusting agent used in the parts of OA apparatuses. However, there have been problems that unevenness in resistance increases due to poor dispersibility of the conductive carbon black in a material, and the hardness of the material increases. Although a plasticizer or the like is usually used to give flexibility to the material, this method causes a problem that the material is contaminated due to bleeding out.

In order to improve the dispersibility of carbon black, studies have been also made on enhancing affinity with solid or liquid substrates by coating the surface of carbon black with various surfactants or resins and on preparing carbon black composite polymers (Patent Document 1).

However, the above studies are not sufficient, and a novel electrical-resistance adjusting agent is required.

### PRIOR ART DOCUMENT

### Patent Document

Patent Document 1: Japanese Unexamined Patent Application Publication No. Hei 10-324819

### SUMMARY OF THE INVENTION

### Problems to be Solved by the Invention

An object of the present invention is to provide an electrical-resistance adjusting agent capable of improving the processability of a composition obtained by blending the electrical-resistance adjusting agent with a rubber, and capable of adjusting the electrical resistance of a molded body obtained from the composition.

Another object of the present invention is to provide an electrical-resistance adjusting agent capable of adjusting the electrical resistance of a molded body obtained from a composition obtained by blending the electrical-resistance adjusting agent with a resin, and capable of reducing the hardness of the molded body.

A preferred object of the present invention is to provide an electrical-resistance adjusting agent capable of improving the processability of a composition obtained by blending the electrical-resistance adjusting agent with at least one selected from a rubber and a resin, capable of adjusting the electrical resistance of a molded body obtained from the composition, and capable of reducing the hardness of the molded body.

### Solutions to the Problems

The inventors have found that the above object can be solved by using a polyether electrical-resistance adjusting agent comprising a polymer that contains 10 to 60 mol % of a structural unit derived from an epihalohydrin (a), 30 to 89 mol % of a structural unit derived from an alkylene oxide (b), and 1 to 15 mol % of a structural unit derived from an ethylenically unsaturated group-containing monomer (c), and that has a weight-average molecular weight of 1,300,000 or less. The invention has been made based on such a finding.

[1] A polyether electrical-resistance adjusting agent, comprising a polymer that contains 10 to 60 mol % of a structural unit derived from an epihalohydrin (a), 30 to 89 mol % of a structural unit derived from an alkylene oxide (b), and 1 to 15 mol % of a structural unit derived from an ethylenically unsaturated group-containing monomer (c), and that has a weight-average molecular weight of 1,300,000 or less.
[2] The polyether electrical-resistance adjusting agent according to [1], wherein the structural unit derived from the epihalohydrin (a) is a structural unit derived from at least one selected from epichlorohydrin and epibromohydrin.
[3] The polyether electrical-resistance adjusting agent according to [1] or [2], wherein the structural unit derived from the alkylene oxide (b) is a structural unit derived from at least one selected from ethylene oxide, propylene oxide and butylene oxide.
[4] The polyether electrical-resistance adjusting agent according to any of [1] to [3], wherein the structural unit derived from the ethylenically unsaturated group-containing monomer (c) is a structural unit derived from glycidyl methacrylate or allyl glycidyl ether.
[5] An electrical-resistance adjusting agent-containing composition comprising the polyether electrical-resistance adjusting agent according to any of [1] to [4] and at least one selected from a rubber and a resin.
[6] The electrical-resistance adjusting agent-containing composition according to [5], wherein the polyether electrical-resistance adjusting agent is contained in an amount of 120 parts by weight or less based on 100 parts by weight of a total amount of the rubber and the resin.
[7] The electrical-resistance adjusting agent-containing composition according to [5] or [6], wherein the composition does not contain a conducting agent other than the polyether electrical-resistance adjusting agent, or when the composition contains a conducting agent other than the polyether electrical-resistance adjusting agent, a content of the conducting agent is 2 parts by weight or less based on 100 parts by weight of the polyether electrical-resistance adjusting agent.
[8] A molded body formed by molding the electrical-resistance adjusting agent-containing composition according to any of [5] to [7].

### Effect of the Invention

By blending the polyether electrical-resistance adjusting agent of the present invention with a rubber to prepare a composition, the processability of the composition can be improved, and the electrical resistance of a molded body obtained from the composition can be adjusted.

Moreover, by blending the polyether electrical-resistance adjusting agent of the present invention with a resin to prepare a composition, the electrical resistance of a molded body obtained from the composition can be adjusted, and the hardness of the molded body can be reduced.

Preferably, by blending the polyether electrical-resistance adjusting agent of the present invention with at least one selected from a rubber and a resin to prepare a composition, the processability of the composition can be improved, the electrical resistance of a molded body obtained from the composition can be adjusted, and the hardness of the molded body can be reduced.

### MODE FOR CARRYING OUT THE INVENTION

The polyether electrical-resistance adjusting agent of the present invention comprises a polymer that contains 10 to 60 mol % of a structural unit derived from an epihalohydrin (a), 30 to 89 mol % of a structural unit derived from an alkylene oxide (b), and 1 to 15 mol % of a structural unit derived from an ethylenically unsaturated group-containing monomer (c), and that has a weight-average molecular weight of 1,300,000 or less.

In the polyether electrical-resistance adjusting agent of the present invention, the structural unit derived from the epihalohydrin (a) is preferably a structural unit derived from at least one selected from epichlorohydrin and epibromohydrin, more preferably a structural unit derived from epichlorohydrin.

In the polyether electrical-resistance adjusting agent of the present invention, the content of the structural unit derived from the epihalohydrin (a) is preferably 45 mol % or less, more preferably 40 mol % or less. In addition, the content of the structural unit derived from the epihalohydrin (a) is preferably 15 mol % or more, more preferably 20 mol % or more.

In the polyether electrical-resistance adjusting agent of the present invention, the structural unit derived from the alkylene oxide (b) is preferably a structural unit derived from at least one selected from ethylene oxide, propylene oxide and butylene oxide, more preferably a structural unit derived from ethylene oxide.

In the polyether electrical-resistance adjusting agent of the present invention, the content of the structural unit derived from the alkylene oxide (b) is preferably 80 mol % or less, more preferably 77 mol % or less. In addition, the content of the structural unit derived from the alkylene oxide (b) is preferably 35 mol % or more, more preferably 40 mol % or more. If the content of the structural unit derived from the alkylene oxide is less than 30 mol %, the electrical resistance cannot be sufficiently lowered. In general, the electrical resistance improves as the content of the alkylene oxide increases. However, if the content of the alkylene oxide is more than 89 mol %, the electrical resistance lowers due to the crystallization of the alkylene oxide.

In the polyether electrical-resistance adjusting agent of the present invention, the structural unit derived from the ethylenically unsaturated group-containing monomer (c) preferably has an oxirane ring such as a glycidyl group. The structural unit derived from the ethylenically unsaturated group-containing monomer having an oxirane ring is preferably a structural unit derived from at least one selected from glycidyl methacrylate and allyl glycidyl ether, particularly preferably a structural unit derived from allyl glycidyl ether.

In the polyether electrical-resistance adjusting agent of the present invention, the content of the structural unit derived from the ethylenically unsaturated group-containing monomer (c) is preferably 13 mol % or less, more preferably 10 mol % or less. The lower limit thereof is more preferably 2 mol % or more, particularly preferably 3 mol % or more.

When the polyether electrical-resistance adjusting agent of the present invention is a copolymer of epichlorohydrin-alkylene oxide-ethylenically unsaturated group-containing monomer, the composition of the copolymer can be determined by the chlorine content therein and the iodine value thereof.

The chlorine content can be measured by a potentiometric titration method in accordance with JIS K7229. The molar fraction of the structural unit derived from epichlorohydrin can be calculated from the chlorine content thus obtained.

The iodine value can be measured by a method in accordance with JIS K6235. The molar fraction of the structural unit derived from the ethylenically unsaturated group-containing monomer can be calculated from the iodine value thus obtained.

The molar fraction of the structural unit derived from the alkylene oxide can be calculated from the molar fraction of the structural unit derived from epichlorohydrin and the molar fraction of the structural unit derived from the ethylenically unsaturated group-containing monomer.

In the polyether electrical-resistance adjusting agent of the present invention, the polymer has a weight-average molecular weight of 1,300,000 or less. The upper limit of the weight average molecular weight is preferably 1,200,000 or less, more preferably 1,150,000 or less. The lower limit of the weight-average molecular weight is preferably 200,000 or more, more preferably 300,000 or more. By using the polymer having a weight-average molecular weight within the above range, the viscosity of the composition and/or the hardness of the molded body can be appropriately reduced without contaminating the material. When the viscosity of the composition and the hardness of the molded body are reduced, the processability can be improved, and when formed into a conductive roller for an OA apparatus, adhesion upon pressing against the roller can be improved.

In the polyether electrical-resistance adjusting agent of the present invention, the polymer preferably has a ratio of the weight-average molecular weight to the number-average molecular weight (weight-average molecular weight/number average molecular weight) of 3 to 10, more preferably 5 to 9, most preferably 5 to 6.5.

In the present invention, the weight-average molecular weight and the number-average molecular weight can be measured in terms of polystyrene by gel permeation chromatography (GPC), using dimethylformamide (DMF) as a solvent.

The polyether electrical-resistance adjusting agent of the present invention can be produced by copolymerizing an epihalohydrin (a), an alkylene oxide (b), and an ethylenically unsaturated group-containing monomer (c) using a catalyst capable of catalyzing ring-opening polymerization of oxirane compounds. The polymerization temperature is, for example, in the range of −20 to 100° C. The polymerization may be either solution polymerization or slurry polymerization. Examples of the catalyst include a catalytic system obtained by reaction of an organoaluminum as a main material with water, a phosphorus oxo acid compound, acetyl acetone, or the like; a catalytic system obtained by reaction of an organozinc as a main material with water; and an organotin-phosphoric ester condensate catalytic system (for example, the organotin-phosphoric ester condensate catalytic system described in U.S. Pat. No. 3,773,694). It is preferable to substantially randomly copolymerize the above-mentioned epihalohydrin (a), alkylene oxide (b), and ethylenically unsaturated group-containing monomer (c).

An electrical-resistance adjusting agent-containing composition of the present invention comprises the polyether electrical-resistance adjusting agent and at least one selected from a rubber and a resin.

The rubber used in the electrical-resistance adjusting agent-containing composition of the present invention is preferably at least one selected from rubbers having an unsaturated carbon-carbon bond in the main chain, such as natural rubber (NR), butadiene rubber (BR), 1,2-polybutadiene (VBR), chloroprene rubber (CR), butyl rubber (IIR), styrene-butadiene rubber (SBR), acrylonitrile-butadiene rubber (NBR), and hydrogenated acrylonitrile-butadiene rubber (H-NBR) (group R); rubbers having a polymethine-type saturated main chain, such as ethylene-propylene-diene rubber (EPDM), chlorosulfonated polyethylene (CSM), acrylic rubber (ACM), and fluoro rubber (M) (group M); rubbers having C, N and O in the main chain, such as urethane rubber (AU) (group U); rubbers having Si and O in the main chain, such as silicone rubber (VMQ) (group Q); rubbers having C and O in the main chain, such as epichlorohydrin rubber (EGO, with a weight-average molecular weight of 800,000 or more) (group O), and the like. Note that when a structural unit of a rubber belonging to the group O is common to those of the above-mentioned electrical-resistance adjusting agent, the rubber belonging to the group O having the common structural unit has a weight-average molecular weight of more than 1,300,000, preferably 1,500,000 or more. As the rubber used in the electrical-resistance adjusting agent-containing composition of the present invention, at least one selected from chloroprene rubber (CR), styrene-butadiene rubber (SBR), acrylonitrile-butadiene rubber (NBR), hydrogenated acrylonitrile-butadiene rubber (H-NBR), ethylene-propylene-diene rubber (EPDM), urethane rubber (AU), and silicone rubber (VMQ) is more preferable, and at least one selected from chloroprene rubber (CR), styrene-butadiene rubber (SBR), acrylonitrile-butadiene rubber (NBR), and ethylene-propylene-diene rubber (EPDM) is particularly preferable.

The above-mentioned rubbers may be used alone or in combination of two or more, and when used in combination of two or more, it is preferable to increase the amount ratio of the rubber with the largest content. The amount ratio of the rubber with the largest content when the rubbers are used in combination of two or more is, for example, 60% by weight or more, preferably 70% by weight or more, more preferably 80% by weight or more based on 100% by weight of the rubbers.

It should be noted that the above-mentioned rubbers are substantially non-liquid rubbers, and even when a liquid rubber is used, the amount thereof is, for example, 10% by weight or less, preferably 5% by weight or less, more preferably 0% by weight based 100% by weight of the rubbers.

The resin used in the electrical-resistance adjusting agent-containing composition of the present invention is preferably a thermoplastic resin, and is preferred to be at least one selected from polyester resins such as polyethylene terephthalate, polycarbonate resins, polystyrene resins, ABS (acrylonitrile-butadiene-styrene) resins, AS (acrylonitrile-styrene) resins, polyamide resins, polyphenylene ether resins, polyethylene resins, polypropylene resins, polyvinyl chloride resins, polyoxymethylene resins, and acrylic resins.

In the electrical-resistance adjusting agent-containing composition of the present invention, the polyether electrical-resistance adjusting agent of the present invention is preferably contained in an amount of 500 parts by weight or less, more preferably 300 parts by weight or less, further preferably 250 parts by weight or less, particularly preferably 120 parts by weight or less, most preferably 100 parts by weight or less, based on 100 parts by weight of the total amount of the rubbers and the resins. The polyether electrical-resistance adjusting agent of the present invention, which has a low molecular weight, exhibits a sufficient effect of lowering electrical resistance even when used in a small amount, whereas even when the polyether electrical-resistance adjusting agent of the present invention is used in an excessive amount, the effect may be saturated. When the effect of lowering electrical resistance is saturated, the using amount may be reduced while considering changes in other physical properties (the viscosity of the composition and the hardness of the molded body). In the present invention, the polyether electrical-resistance adjusting agent is preferably contained in an amount of 5 parts by weight or more, more preferably 10 parts by weight or more, further preferably 20 parts by weight or more, particularly preferably 35 parts by weight or more, and most preferably 40 parts by weight or more, based on 100 parts by weight of the total amount of the rubbers and the resins.

The electrical-resistance adjusting agent-containing composition of the present invention may contain a crosslinking agent, and may also contain a crosslinking accelerator together with the crosslinking agent.

As the crosslinking agent that can be used in the electrical-resistance adjusting agent-containing composition of the present invention, a known crosslinking agent utilizing the reactivity of a chlorine atom, such as polyamines, thioureas, thiadiazoles, triazines, quinoxalines, and bisphenols, and a known crosslinking agent utilizing the reactivity of a side chain double bond, such as organic peroxides, sulfur, and sulfides, can be given.

Examples of polyamines include ethylenediamine, hexamethylenediamine, diethylenetriamine, triethylenetetramine, hexamethylenetetramine, p-phenylenediamine, cumendiamine, N,N′-dicinnamylidene-1,6-hexanediamine, ethylenediamine carbamate, and hexamethylenediamine carbamate.

Examples of thioureas include ethylene thiourea, 1,3-diethyl thiourea, 1,3-dibutyl thiourea, and trimethyl thiourea.

Examples of thiadiazoles include 2,5-dimercapto-1,3,4-thiadiazole and 2-mercapto-1,3,4-thiadiazole-5-thiobenzoate.

Examples of triazines include 2,4,6-trimercapto-1,3,5-triazine, 2-hexylamino-4,6-dimercaptotriazine, 2-diethylamino-4,6-dimercaptotriazine, 2-cyclohexylamino-4,6-dimercaptotriazine, 2-dibutylamino-4,6-dimercaptotriazine, 2-anilino-4,6-dimercaptotriazine, and 2-phenylamino-4,6-dimercaptotriazine.

Examples of the quinoxalines include a 2,3-dimercaptoquinoxaline derivative such as quinoxaline-2,3-dithiocarbonate, 6-methylquinoxaline-2,3-dithiocarbonate, 6-ethyl-2,3-dimercaptoquinoxaline, 6-isopropyl quinoxaline-2,3-dithiocarbonate, and 5,8-dimethylquinoxaline-2,3-dithiocarbonate.

Examples of bisphenols include 4,4′-dihydroxydiphenyl sulfoxide, 4,4′-dihydroxydiphenyl sulfone (bisphenol 1,1-cyclohexylidene-bis(4-hydroxybenzene), 2-chloro-1,4-cyclohexylene-bis(4-hydroxybenzene), 2,2-isopropylidene-bis(4-hydroxybenzene) (bisphenol A), hexafluoroisopropylidene-bis(4-hydroxybenzene) (bisphenol AF), and 2-fluoro-1,4-phenylene-bis(4-hydroxybenzene).

Examples of organic peroxides include tert-butyl hydroperoxide, 1,1,3,3-tetramethylbutyl hydroperoxide, cumene hydroperoxide, diisopropylbenzene hydroperoxide, di-tert-butyl peroxide, dicumyl peroxide, tert-butyl cumyl peroxide, 1,1-tert-butyl peroxycyclohexane, 2,5-dimethyl-2,5-ditert-butyl peroxyhexane, 2,5-dimethyl-2,5-ditert-dibutylperoxyhexyne-3, 1,3-bistert-butylperoxyisopropylbenzene, 2,5-dimethyl-2,5-dibenzoylperoxyhexane, bistert-butylperoxy-3,3,5-trimethylcyclohexane, n-butyl-4,4-bistert-butylperoxyvalerate, benzoyl peroxide, tert-butyl peroxide isobutyrate, tert-butylperoxy 2-ethylhexanoate, tert-butyl peroxybenzoate, tert-butyl peroxyisopropyl carbonate, tert-butyl peroxyallylmonocarbonate, and p-methyl benzoyl peroxide.

Examples of sulfides include morpholine disulfide, tetramethylthiuram disulfide, tetraethylthiuram disulfide, tetrabutylthiuram disulfide, N,N′-dimethyl-N,N′-diphenylthiuram disulfide, dipentanemethylenethiuram tetrasulfide, dipentamethylenethiuram tetrasulfide, and dipentamethylenethiuram hexasulfide.

The blending amount of the crosslinking agent in the electrical-resistance adjusting agent-containing composition of the present invention is preferably 0.1 to 20 parts by weight, more preferably 0.1 to 10 parts by weight, particularly preferably 0.1 to 5 parts by weight based on 100 parts by weight of the electrical-resistance adjusting agent.

The crosslinking accelerator that can be used in the electrical-resistance adjusting agent-containing composition of the present invention is not particularly limited as long as it is a known crosslinking accelerator. Examples of the crosslinking accelerator include a thiuram-based crosslinking accelerator, thiazole-based crosslinking accelerator, morpholine sulfide-based crosslinking accelerator, sulfenamide-based crosslinking accelerator, guanidine-based crosslinking accelerator, thiourea-based crosslinking accelerator, aldehyde-ammonia-based crosslinking accelerator, dithiocarbamate-based crosslinking accelerator, xanthogenate-based crosslinking accelerator, fatty acid alkali metal salt-based crosslinking accelerator, 1,8-diazabicyclo(5,4,0)undecene-7 (hereinafter abbreviated as DBU) salt-based crosslinking accelerator, and 1,5-diazabicyclo(4,3,0)nonene-5 (hereinafter abbreviated as DBN) salt-based crosslinking accelerator. When using sulfur as the crosslinking agent, zinc white can be used as the crosslinking accelerator.

lue of Examples of the thiuram-based crosslinking accelerator include

Examples of the thiuram-based crosslinking accelerator include tetramethylthiuram disulfide, tetraethylthiuram disulfide, tetrabutylthiuram disulfide, dipentamethylenethiuram tetrasulfide, dipentamethylenethiuram hexasulfide, and tetramethylthiuram monosulfide.

Examples of the thiazole-based crosslinking accelerator include mercaptobenzothiazole, dibenzothiazyl disulfide, various metal salts of 2-mercaptobenzothiazole, cyclohexylamine salts of 2-mercaptobenzothiazole, 2-(N,N-diethylthiocarbamoylthio)benzothiazole, 2-(4′-morpholinodithio)benzothiazole, and di-2-benzothiazolyl disulfide.

Examples of the morpholine sulfide-based crosslinking accelerator include morpholine disulfide.

Examples of the sulfenamide-based crosslinking accelerator include N-cyclohexyl-2-benzothiazylsulfenamide, N,N-dicyclohexyl-2-benzothiazylsulfenamide, N-oxydiethylene-2-benzothiazylsulfenamide, tert-butyl-2-benzothiazylsulfenamide, and N-tert-butyl-di(2-benzothiazole)sulfenimide.

Examples of the guanidine-based crosslinking accelerator include diphenylguanidine and ditolylguanidine.

Examples of the thiourea-based crosslinking accelerator include ethylenethiourea, diethylenethiourea, dibutylthiourea, dilaurylthiourea, trimethylthiourea and diphenylthiourea.

Examples of the aldehyde-ammonia-based crosslinking accelerator include hexamethylenetetramine.

Examples of the dithiocarbamate-based crosslinking accelerator include zinc dimethyldithiocarbamate, zinc diethylcarbamate, and zinc N-pentamethylenedithiocarbamate.

Examples of the xanthogenate-based crosslinking accelerator include zinc isopropylxanthogenate and zinc butylxanthogenate.

Examples of the fatty acid alkali metal salt-based crosslinking accelerator include sodium stearate and potassium stearate.

Examples of the DBU salt-based crosslinking accelerator include DIM-carbonates, DBU-stearates, DBU-2-ethylhexylates, DBU-benzoates, DBU-salicylates, DBU-3-hydroxy-2-naphthoates, DBU-phenol resin salts, DBU-2-mercaptobenzothiazole salts, and DBU-2-mercaptobenzimidazole salts.

Examples of the DBN salt-based crosslinking accelerator include DBN-carbonates, DBN-stearates, DBN-2-ethylhexylates, DBN-benzoates, DBN-salicylates, DBN-3-hydroxy-2-naphthoates, DBN-phenol resin salts, DBN-2-mercaptobenzothiazole salts, and DBN-2-mercaptobenzimidazole salts.

The blending amount of the crosslinking accelerator in the electrical-resistance adjusting agent-containing composition of the present invention is preferably 0.1 to 15 parts by weight, more preferably 0.1 to 10 parts by weight, particularly preferably 0.1 to 5 parts by weight, based on 100 parts by weight of the electrical-resistance adjusting agent.

The total blending amount of the crosslinking agent and the crosslinking accelerator in the electrical-resistance adjusting agent-containing composition of the present invention is, for example, 0.1 to 20 parts by weight, preferably 0.3 to 10 parts by weight, more preferably 0.5 to 5 parts by weight, based on 100 parts by weight of the total amount of the rubber, the resin and the electrical-resistance adjusting agent.

As long as the advantageous effects of the present invention are not impaired, in addition to the above-mentioned components, various additives such as an acid acceptor, filler, plasticizer, processing aid, flame retardant, pigment, anti-aging agent, and conductive agent (except for the polyether electrical-resistance adjusting agent of the present invention) may be optionally blended into the electrical-resistance adjusting agent-containing composition of the present invention, as commonly performed in the technical field.

The acid acceptor used in the present invention may be a known acid acceptor. When the known crosslinking agent utilizing the reactivity of a side chain double bond is used, the acid acceptor may not be used. The acid acceptor is preferably a metal compound and/or an inorganic microporous crystal. Examples of the metal compound include oxides, hydroxides, carbonates, carboxylates, silicates, borates, and phosphites of any metal belonging to Group II (Groups 2 and 12) in the periodic table; oxides, hydroxides, carboxylates, silicates, sulfates, nitrates, and phosphates of any metal belonging to Group III (Groups 3 and 13) in the periodic table; and oxides, basic carbonates, basic carboxylates, basic phosphites, basic sulfites, and tribasic sulfates of any metal belonging to Group IV (Groups 4 and 14) in the periodic table.

Specific examples of the metal compound include magnesia, magnesium hydroxide, aluminum hydroxide, barium hydroxide, sodium carbonate, magnesium carbonate, barium carbonate, quicklime, slaked lime, calcium carbonate, calcium silicate, calcium stearate, zinc stearate, calcium phthalate, calcium phosphite, zinc white (zinc oxide), tin oxide, litharge, red lead, white lead, dibasic lead phthalate, dibasic lead carbonate, tin stearate, basic lead phosphite, basic tin phosphite, basic lead sulfite, and tribasic lead sulfate, Preferred are sodium carbonate, magnesia, magnesium hydroxide, quicklime, slaked lime, calcium carbonate, calcium silicate, and zinc white. Note that when using sulfur as a crosslinking agent, the zinc white corresponds to a crosslinking accelerator.

The inorganic microporous crystal means a crystalline porous body, which is clearly distinguishable from an amorphous porous body such as silica gel and alumina. Examples of the inorganic microporous crystal include a zeolite, an alumina phosphate type molecular sieve, a layered silicate, a synthetic hydrotalcite, and an alkali metal titanate. Particularly preferred acid acceptor includes a synthetic hydrotalcite.

Examples of the zeolite include various kinds of zeolite such as a natural zeolite, a synthetic zeolite of type A, X, and Y, a sodalite, a natural or synthetic mordenite, and a ZSM-5, and a metal substitute thereof. The zeolite may be used alone or in combination of two or more. A metal of the metal substitute is often sodium. The zeolite is preferably a zeolite having a large acid accepting capacity, more preferably type A zeolite.

The synthetic hydrotalcite is represented by the following general formula (1):

Mg_{X}Zn_{Y}Al_{Z}(OH)_{(2(X+Y)+3Z-2)}CO₃-wH₂O (1)

wherein X and Y each represent numbers of 0 to 10 having a relationship of X+Y=1 to 10, Z represents a number of 1 to 5, and w represents a number of 0 to 10, respectively.

Specific examples of the hydrotalcite represented by the general formula (1) include Mg_{4.5}Al₂(OH)₁₃CO₃.3.5H₂O, Mg_{4.5}Al₂(OH)₁₃CO₃, Mg₄Al₂(OH)₁₂CO₃.3.5H₂O, Mg₆Al₂(OH)₁₆CO₃.4H₂O, Mg₅Al₂(OH)₁₄CO₃.4H₂O, Mg₃Al₂(OH)₁₀CO₃.1.7H₂O, Mg₃ZnAl₂(OH)₁₂CO₃.3.5H₂O, and Mg₃ZnAl₂(OH)₁₂CO₃.

The blending amount of the acid acceptor in the electrical-resistance adjusting agent-containing composition of the present invention can be appropriately adjusted each in the case of performing a crosslinking reaction utilizing the reactivity of a side chain double bond (case A) and in the case of performing a crosslinking reaction other than the case A (for example, a crosslinking reaction utilizing reactivity of a chlorine atom) (case B). In the case A, the blending amount of the acid acceptor is, for example, 0 to 200 parts by weight, preferably 0 to 50 parts by weight, and may be 0 parts by weight, based on 100 parts by weight of the polyether electrical-resistance adjusting agent. In the case B, the blending amount of the acid acceptor may be 0.1 to 50 parts by weight, 30 to 150 parts by weight, or 80 to 150 parts by weight, based on 100 parts by weight of the polyether electrical-resistance adjusting agent.

Examples of the filler include carbonates such as magnesium carbonate, aluminum carbonate, calcium carbonate, and barium carbonate; silicates such as magnesium silicate, calcium silicate, sodium silicate, and aluminum silicate; sulfates such as aluminum sulfate, calcium sulfate, and barium sulfate; synthetic hydrotalcite; metal sulfides such as molybdenum disulfide, iron sulfide, and copper sulfide; diatomite, asbestos, lithopone (zinc sulfide/barium, sulfide), graphite, carbon black, carbon fluoride, calcium fluoride, coke, quartz fine powder, zinc white, talc, mica powder, wollastonite, carbon fiber, aramid fiber, a variety of whiskers, glass fiber, organic reinforcing agents, and organic fillers.

The amount of the filler can be appropriately adjusted, and may be 0 to 200 parts by weight, 0 to 150 parts by weight, or 0 parts by weight, based on 100 parts by weight of the polyether electrical-resistance adjusting agent.

Examples of the processing aid used in the present invention include higher fatty acids such as stearic acid, oleic acid, palmitic acid, and lauric acid; higher fatty acid amides such as stearamide and oleamide; higher fatty acid esters such as ethyl oleate; higher aliphatic amines such as stearyl amine and oleyl amine; petroleum-based waxes such as carnauba wax and ceresin wax; polyglycols such as ethylene glycol, glycerol, and diethylene glycol; aliphatic hydrocarbons such as vaseline, paraffin and naphthene; silicone oils, silicone polymers, low molecular weight polyethylene, phthalic acid esters, phosphoric acid esters, rosin, (halogenated) dialkyl amines, and (halogenated) dialkyl sulfones.

The blending amount of the processing aid in the electrical-resistance adjusting agent-containing composition of the present invention is, for example, 500 parts by weight or less, preferably 300 parts by weight or less, more preferably 100 parts by weight or less, particularly preferably 50 parts by weight or less, based on 100 parts by weight of the electrical-resistance adjusting agent.

The anti-aging agent used in the present invention may be a known anti-aging agent. Examples of the anti-aging agent include phenyl-α-naphthylamine, p-toluenesulfonylamide-diphenylamine, 4,4-α,α-dimethylbenzyldiphenylamine, a high-temperature reaction product of diphenylamine and acetone, a low-temperature reaction product of diphenylamine and acetone, a low-temperature reaction product of diphenylamine, aniline and acetone, a reaction product of diphenylamine and diisobutylene, octylated diphenylamine, substituted diphenylamine, alkylated diphenylamine, diphenylamine derivatives, N,N′-diphenyl-p-phenylenediamine, N-isopropyl-N′-phenyl-p-phenylenediamine, N,N′-di-2-naphthyl-p-phenylenediamine, N-phenyl-N′-3-methacryloyloxy-2-hydroxypropyl-p-phenylenediamine, N,N′-bis-1-methylheptyl-p-phenylenediamine, N,N′-bis-1,4-dimethylpentyl-p-phenylenediamine, N-1,3-dimethylbutyl-N′-phenyl-p-phenylenediamine, a mixture product of diallyl-p-phenylenediamine, phenyl-octyl-p-phenylenediamine, a mixture product of phenyl-α-naphthylamine and diphenyl-p-phenylenediamine, a polymer of 2,2,4-trimethyl-1,2-dihydroquinoline, 6-ethoxy-2,2,4-trimethyl-1,2-dihydroquinoline, 2,5-di-tert-amylhydroquinone, 2,5-di-tert-butylhydroquinone, 1-oxy-3-methyl-4-isopropylbenzene, 2,6-di-tert-butyl-4-ethylphenol, butylhydroxyanisole, 2,6-di-tert-butyl-α-dimethylamino-p-cresol, a mixture product of 2,6-di-tert-butylphenol, 2,4,6-tri-tert-butylphenol and ortho-tert-butylphenol, styrenated phenol, alkylated phenol, a mixture product of alkyl- and aralkyl-substituted phenols, phenol derivatives, 2,2′-methylene-bis-4-methyl-6-Cert-butylphenol, methylene-bis-4-methyl-6-cyclohexylphenol, 2,2′-methylene-bis-4-ethyl-6-tert-butylphenol, 4,4′-methylene-bis-2,6-di-tert-butylphenol, methylene-crosslinked polyvalent alkylphenol, alkylated bisphenol, a butylated reaction product of p-cresol and dicyclopentadiene, a mixture of polybutylated bisphenol A, 4,4′-thiobis-6-tert-butyl-3-methylphenol (also known as 4,4′-thio-bis(6-tert-butyl-m-cresol)), 4,4′-butylidenebis-3-methyl-6-tert-butylphenol, 2,4-bisoctylthiomethyl-o-cresol, hindered phenol, hindered bisphenol, 2-mercaptobenzimidazole, 2-mercaptomethylbenzimidazole, a zinc salt of 2-mercaptobenzimidazole, a zinc salt of 2-mercaptornethylbenzimidazole, 4-mercaptomethylbenzimidazole, 5-mercaptomethylbenzimidazole, a zinc salt of 4-mercaptornethylbenzimidazole, a zinc salt of 5-mercaptomethylbenzimidazole, dioctadecyl disulfide, nickel diethyldithiocarbamate, nickel dibutyldithiocarbamate, 1,3-bisdimethylaminopropyl-2-thiourea, tributylthiourea, bis-2-methyl-4-3-n-alkylthiopropionyloxy-5-tert-butylphenyl sulfide, bis-3,5-di-tert-butyl-4-hydroxybenzyl sulfide, mixed lauryl and stearyl thiodipropionates, cyclic acetal, a mixture product of 60% polymer polyol and 40% hydrogenated silica, an especial polyethylene glycol processed product having a two-molecule structure of polyethylene and polyethylene glycol, an especial designed mixture product of an inactive filler and polymer polyol, a composite anti-aging agent, enol ether, 1,2,3-benzotriazole, 3-N-salicyloylamino-1,2,4-triazole, a triazine type derivative composite, decamethylenedicarboxylic acid disalicyloylhydrazide, N,N′-bis-3,3,5-di-tert-4-hydroxyphenylpropionylhydrazine, and tetrakis-methylene-3,3′,5′-di-tert-butyl-4′-hydroxyphenylpropionate methane.

The blending amount of the anti-aging agent in the electrical-resistance adjusting agent-containing composition of the present invention is, for example, 30 parts by weight or less, preferably 10 parts by weight or less, more preferably 5 parts by weight or less, based on 100 parts by weight of the polyether electrical-resistance adjusting agent.

The conductive agent used in the present invention may be a known conductive agent. Examples of the conductive agent include carbon materials, inorganic ionic substances, surfactants, quaternary ammonium salts, and lithium salts of organic acids. Specific examples thereof include carbon black, graphite, sodium, perchlorate, lithium perchlorate, calcium perchlorate, tetrabutylammonium bromide, tetrabutylammonium perchlorate, ethyltributylammonium ethosulfate, lauryltrimethylammonium chloride, stearyltrimethylammonium chloride, octadecyltrimethylammonium chloride, dodecyltrimethylammonium chloride, hexadecyltrimethylammonium chloride, trioctylpropylammonium bromide, dimethylalkyllauryl betaine, and lithium trifluoromethanesulfonate.

From the viewpoint of maximizing the effect of using the polyether electrical-resistance adjusting agent in the present invention, the electrical-resistance adjusting agent-containing composition of the present invention preferably does not contain the above-mentioned conductive agent. If the electrical-resistance adjusting agent-containing composition contains the conductive agent, the amount of the conductive agent is recommended to be, for example, 100 parts by weight or less, preferably 30 parts by weight or less, more preferably 10 parts by weight or less, particularly preferably 2 parts by weight or less, most preferably 0.5 parts by weight or less, based on 100 parts by weight of the polyether electrical-resistance adjusting agent.

A method for producing the electrical-resistance adjusting agent-containing composition of the present invention is not particularly limited, and normally used methods may be employed. Examples thereof include methods by a mixing roll, a Banbury mixer, or various kneaders.

A method for molding the electrical-resistance adjusting agent-containing composition of the present invention is not particularly limited, and normally used methods may be employed. Examples thereof include compression molding using a mold, extrusion molding, and injection molding.

The characteristics of the electrical-resistance adjusting agent-containing composition of the present invention are separately described in the case where the composition contains a rubber (hereinafter referred to as a rubber composition) and the case where the composition contains a resin (hereinafter referred to as a resin composition). As for the rubber composition of the present invention containing the polyether electrical-resistance adjusting agent, the processability of the composition is improved, and the electrical resistance of a molded body obtained from the composition is also lowered. In addition, the hardness of the molded body may be reduced.

The minimum viscosity (Vin) according to the Mooney scorch test of the rubber composition of the present invention, which varies depending on the rubber used, is preferably 50 or less, more preferably 40 or less, further preferably 30 or less. The lower limit of the minimum viscosity is not particularly limited, but may be 1 or more, or 10 or more.

The hardness (JIS A) of a molded body obtained from the rubber composition of the present invention, which varies depending on the rubber used, is preferably 70 or less, more preferably 60 or less, further preferably 55 or less. The lower limit of the hardness is not particularly limited, but may be 10 or more, or 15 or more.

The volume resistivity (×10⁷ Ω·cm) of a molded body obtained from the rubber composition of the present invention varies depending on the rubber used. For example, when the rubber used belongs to the group M including EPDM and the like, the volume resistivity (×10⁷ Ω·cm) is preferably 70000 or less, more preferably 500 or less, further preferably 200 or less. The lower limit of the volume resistivity (×10⁷ Ω·cm) when the rubber used belongs to the group M is not particularly limited, but may be 50 or more, or 100 or more. The volume resistivity (×10⁷ Ω·cm) when the rubber used belongs to the group R is preferably 100 or less, more preferably 50 or less, further preferably 10 or less. The lower limit of the volume resistivity (×10⁷ Ω·cm) when the rubber used belongs to the group M is not particularly limited, but may be 0.1 or more, or 1 or more.

The resin composition of the present invention containing the polyether electrical-resistance adjusting agent allows the electrical resistance of a molded body obtained from the composition to lower and the hardness of the molded body to reduce.

The hardness (SHORE D) of a molded body obtained from the resin composition of the present invention, which varies depending on the resin used, is preferably 100 or less, more preferably 80 or less, further preferably 65 or less. The lower limit thereof is not particularly limited, but may be 30 or more, or 50 or more.

The volume resistivity (×10⁷ Ω·cm) of a molded body obtained from the resin composition of the present invention, which varies depending on the resin used, is preferably 10000 or less, more preferably 1000 or less, further preferably 500 or less. The lower limit thereof is not particularly limited, but may be 100 or more, or 300 or more.

The molded body of the present invention may be a molded body obtained by crosslinking the electrical-resistance adjusting agent-containing composition. The crosslinking reaction may be carried out before, during or after molding. When the crosslinking agent is used, the crosslinking reaction is usually carried out by heating to 100° C. to 200° C., and the crosslinking time varies depending on the temperature, but is usually from 0.5 minutes to 300 minutes.

This application claims benefit of priority based on Japanese Patent Application No, 2017-072359 filed on Mar. 31, 2017. The entire content of the specification of Japanese Patent Application No. 2017-072359 filed on Mar. 31, 2017 is incorporated herein by reference.

### EXAMPLES

Hereinbelow, the present invention will be more specifically described in examples and comparative examples, but the present invention is not limited to these descriptions.

### Synthesis of Polymerization Catalyst

Into a three-necked flask equipped with a thermometer and a stirrer were charged 10.0 g of dibutyltin oxide and 23.4 g of tributyl phosphate. While stirred in a nitrogen gas flow, the resultant liquid was heated at 260° C. for 15 minutes to distill off the distilled product, so that a solid condensed substance as a remaining product was yielded. This condensed substance was used as a catalyst to conduct the following polymerization.

### Example 1

The inside of an SUS reactor (equipped with a thermometer and a stirrer) having an internal volume of 20 L was purged with nitrogen, and thereinto were charged 7.2 g of the condensed substance catalyst, 4500 g of n-hexane having a water content of 10 ppm or less, 580 g of epichlorohydrin, 60% (i.e., 516 g) of the amount of 860 g of ethylene oxide, 120 g of allyl glycidyl ether, and 2.31 g of t-butanol to cause the components to react at 35° C. for 20 hours. At 1.5 hours and 2.5 hours after the start of the reaction period, 25% (i.e., 215 g) and 15% (i.e., 129 g) of the amount of 860 g of ethylene oxide were added thereto, respectively. The reaction solvent was removed, and then the resultant was dried at 60° C. under a reduced pressure for 8 hours to obtain an electrical-resistance adjusting agent of Example 1 having the copolymerization composition as shown in Table 1.

### Comparative Example 1

An epichlorohydrin-ethylene oxide-allyl glycidyl ether terpolymer “EPION-301” manufactured by Osaka Soda Co., Ltd. was used as an electrical-resistance adjusting agent of Comparative Example 1.

The copolymerization composition of each of the electrical-resistance adjusting agents thus obtained was determined by the chlorine content therein and the iodine value thereof. The chlorine content was determined by a potentiometric titration method in accordance with JIS K7229.

The potentiometric titration was performed using a potentiometric titrator AT-420N manufactured by Kyoto Electronics Manufacturing Co., Ltd. having composite silver electrodes C-878 as electrodes. From the resultant chlorine content, the molar fraction of structural units derived from epichlorohydrin was calculated.

The iodine value was measured by a method in accordance with JIS K6235. To a stoppered flask were added about 0.70 g of a sample and 80 mL of chloroform, and the resultant was heated to 40° C. to dissolve the sample. Thereafter, thereto were added 20 mL of a Wijs reagent and 10 mL of an aqueous solution of sodium acetate. The resultant was sufficiently shaken, and then allowed to stand still in a dark place for 20 minutes. Next, thereto was added 5 mL of a 20% aqueous solution of potassium iodide, and then the resultant was sufficiently shaken. Thereafter, an automatic titrator having a platinum micro composite electrode (redox titration) was used to perform potentiometric titration with a 0.1N aqueous solution of sodium thiosulfate. From the resultant iodine value, the molar fraction of structural units derived from the ethylenically unsaturated group-containing monomer was calculated.

The molar fraction of the alkylene oxide was calculated from the molar fraction of the structural units derived from epichlorohydrin and the molar fraction of the structural units derived from the ethylenically unsaturated group-containing monomer.

### Method for Measuring Molecular Weight

The polymer was dissolved in dimethylformamide (DMF) as a solvent, and the resultant solution was subjected to gel permeation chromatography (GPC) to determine a molecular weight distribution in terms of polystyrene. Then, based on the distribution, the number-average molecular weight and the weight-average molecular weight were determined. That is, a GPC apparatus RID-6A manufactured by Shimadzu Corporation and columns RD-807, RD-806, KD-806M and ED-803 manufactured by Shodex were used to perform the measurement under conditions of a flow rate of 1.0 mL/min, a concentration of 20 mg polymer/8 mL DMF, an injection volume of 50 μL, and a column temperature of 40° C.

TABLE 1

| | | | Comparative*¹ |
|---|---|---|---|
| | | Example 1 | Example 1 |
| copolymerization | (1) epichlorohydrin | 23 | 24 |
| composition | (2) ethylene oxide | 73 | 72 |
| (mol %) | (3) allyl glycidyl ether | 4 | 4 |

| | | |
|---|---|---|
| weight-average molecular weight | 1,150,000 | 1,680,000 |
| number-average molecular weight | 170,000 | 280,000 |
| weight-average molecular | 6.9 | 6.0 |
| weight/number-average | | |
| molecular weight | | |

*¹epichlorohydrin-ethylene oxide-allyl glycidyl ether terpolymer “EPION-301” manufactured by Osaka Soda Co., Ltd

### Examples 2 to 6 and Comparative Examples 2 to 6

Materials with the blends shown in Tables 2 and 3 were kneaded with a kneader and an open roll to prepare uncrosslinked rubber sheets having a thickness of 2 to 2.5 mm. The obtained uncrosslinked rubber sheets of Examples 2 to 6 and Comparative Examples 2 to 6 were press-crosslinked at 170° C. for 15 minutes to obtain crosslinked sheets having a thickness of 2 mm.

### Table 2

TABLE 2

| | Exam- | Exam- | Exam- | Exam- | Exam- |
|---|---|---|---|---|---|
| | ple 2 | ple 3 | ple 4 | ple 5 | ple 6 |
| electrical- | 30 | 50 | 70 | 50 | 30 |
| resistance adjusting | | | | | |
| agent of | | | | | |
| Example 1 | | | | | |
| acrylonitrile- | 70 | 50 | 30 | | |
| butadiene | | | | | |
| rubber*² | | | | | |
| chloroprene | | | | 50 | |
| rubber*³ | | | | | |
| ethylene- | | | | | 70 |
| propylene-diene | | | | | |
| rubber*⁴ | | | | | |
| precipitated | 10 | 10 | 10 | 10 | 10 |
| calcium | | | | | |
| carbonate*⁵ | | | | | |
| dicumyl | 1 | 1 | 1 | 1 | 1 |
| peroxide*⁶ | | | | | |

Unit: part(s) by weight
*²“N250S” manufactured by JSR Corporation
*³“Showa Denko Chloroprene WXJ” manufactured by Showa Denko K.K.
*⁴“ESPRENE 505A” manufactured by Sumitomo Chemical Co., Ltd.
*⁵“Silver-W” manufactured by SHIRAISHI CALCIUM KASHA, LTD.
*⁶“PERCUMYL D” manufactured by NOF CORPORATION

TABLE 3

| | Compar- | Compar- | Compar- | Compar- | Compar- |
|---|---|---|---|---|---|
| | ative | ative | ative | ative | ative |
| | Exam- | Exam- | Exam- | Exam- | Exam- |
| | ple 2 | ple 3 | ple 4 | ple 5 | ple 6 |
| electrical- | 30 | 50 | 70 | 50 | 30 |
| resistance | | | | | |
| adjusting | | | | | |
| agent of | | | | | |
| Comparative | | | | | |
| Example 1 | | | | | |
| acrylonitrile- | 70 | 50 | 30 | | |
| butadiene | | | | | |
| rubber*² | | | | | |
| chloroprene | | | | 50 | |
| rubber*³ | | | | | |
| ethylene- | | | | | 70 |
| propylene- | | | | | |
| diene | | | | | |
| rubber*⁴ | | | | | |
| precipitated | 10 | 10 | 10 | 10 | 10 |
| calcium | | | | | |
| carbonate*⁵ | | | | | |
| dicumyl | 1 | 1 | 1 | 1 | 1 |
| peroxide*⁶ | | | | | |

Unit: part(s) by weight
*²“N250S” manufactured by JSR Corporation
*³“Showa Denko Chloroprene WXJ” manufactured by Showa Denko K.K.
*⁴“ESPRENE SOSA” manufactured by Sumitomo Chemical Co., Ltd.
*⁵“Silver-W” manufactured by SHIRAISHI CALCIUM KAISHA, LTD.
*⁶“PERCUMYL D” manufactured by NOF CORPORATION

### <Minimum Viscosity in Mooney Scorch Test>

The minimum viscosity (Vm) of each of the uncrosslinked rubber sheets after kneading was measured in accordance with a method described in JIS K6300, Mooney viscometer AM-3 manufactured by Toyo Seiki Seisaku-sho, Ltd, and an L-type rotor were used to perform the measurement at a measurement temperature of 120° C. The results are shown in Tables 4 and 5.

### <Measurement of Volume Resistivity>

Each of the obtained crosslinked sheets was conditioned under an environment of a temperature of 23° C. and a relative humidity (RH) of 50%. Then, HIRESTA (manufactured by Mitsubishi Petrochemical) using double-ring electrodes was used to measure the volume resistivity of the crosslinked sheet in accordance with JIS K6271. The results are shown in Tables 4 and 5.

### <Measurement of Rubber Hardness>

ASKER type-A durometer manufactured by Kobunshi Keiki Co., Ltd. was used to measure the rubber hardness of each of the obtained crosslinked sheets in accordance with JIS K6253, The results are shown in Tables 4 and 5.

TABLE 4

| | Example 2 | Example 3 | Example 4 | Example 5 | Example 6 |
|---|---|---|---|---|---|
| minimum | 30 | 22 | 18 | 11 | 10 |
| viscosity | | | | | |
| (Vm) | | | | | |
| hardness | 47 | 43 | 40 | 15 | 41 |
| (JIS A) | | | | | |
| volume | 2.1 × 10⁸ | 2.6 × 10⁷ | 2.1 × 10⁷ | 2.7 × 10⁷ | 6.8 × 10¹¹ |
| resistivity | | | | | |
| (Ω · cm) | | | | | |

TABLE 5

| | Compar- | Compar- | Compar- | Compar- | Compar- |
|---|---|---|---|---|---|
| | ative | ative | ative | ative | ative |
| | Example 2 | Example 3 | Example 4 | Example 5 | Example 6 |
| minimum | 41 | 43 | 47 | 35 | 22 |
| viscosity | | | | | |
| (Vm) | | | | | |
| hardness | 50 | 47 | 45 | 28 | 44 |
| (JIS A) | | | | | |
| volume | 1.9 × 10⁸ | 3.0 × 10⁷ | 1.9 × 10⁷ | 2..3 × 10⁷ | 7.4 × 10¹¹ |
| resistivity | | | | | |
| (Ω · cm) | | | | | |

As shown in Tables 4 and 5, by using the polyether electrical-resistance adjusting agent of the present invention, it is possible to improve the processability of the composition, lower the resistivity of the molded body (crosslinked body), and reduce the hardness of the molded body.

### Examples 7 to 10 and Comparative Examples 7 to 14

Materials with the blends shown in Tables 6 and 7 were kneaded with a kneader and an open roll to prepare uncrosslinked rubber sheets having a thickness of 2 to 2.5 mm. The obtained uncrosslinked rubber sheets of Examples 7 to 10 and Comparative Examples 7 to 14 were press-crosslinked at 170° C. for 15 minutes to obtain crosslinked sheets having a thickness of 2 min.

TABLE 6

| | Comparative | Comparative | | Comparative | Comparative | |
|---|---|---|---|---|---|---|
| | Example 7 | Example 8 | Example 7 | Example 9 | Example 10 | Example 8 |
| electrical-resistance | | 30 | | | 30 | |
| adjusting agent of | | | | | | |
| Comparative Example 1 | | | | | | |
| electrical-resistance | | | 30 | | | 30 |
| adjusting agent of | | | | | | |
| Example 1 | | | | | | |
| styrene-butadiene rubber*¹ | 100 | 70 | 70 | | | |
| acrylonitrile-butadiene | | | | 100 | 70 | 70 |
| rubber*² | | | | | | |
| stearic acid | 1 | 1 | 1 | 1 | 1 | 1 |
| precipitated calcium | 30 | 30 | 30 | 30 | 30 | 30 |
| carbonate*³ | | | | | | |
| 4,4′-thio-bis(6-tert-butyl-m- | 0.5 | 0.5 | 0.5 | 0.5 | 0.5 | 0.5 |
| cresol)*⁴ | | | | | | |
| zinc oxide*⁵ | 5 | 5 | 5 | 5 | 5 | 5 |
| di-2-benzothiazolyl | 1 | 1 | 1 | 1 | 1 | 1 |
| disulfide*⁶ | | | | | | |
| tetramethylthiuram | | | | 0.5 | 0.5 | 0.5 |
| monosulfide*⁷ | | | | | | |
| tetramethylthiuram | 0.3 | 0.3 | 0.3 | | | |
| disulfide*⁸ | | | | | | |
| dipentamethylenethiuram | 0.5 | 0.5 | 0.5 | | | |
| tetrasulfide*⁹ | | | | | | |
| sulfur | 1.5 | 1.5 | 1.5 | 1 | 1 | 1 |
| total amount | 139.8 | 139.8 | 139.8 | 139.0 | 139.0 | 139.0 |

Unit: part(s) by weight
*¹“JSR 1502” manufactured by JSR Corporation
*²“JSR N250S” manufactured by JSR Corporation
*³“Silver-W” manufactured by SHIRAISHI CALCIUM KAISHA, LTD.
*⁴“ANTAGE CRYSTAL” manufactured by Kawaguchi Chemical Industry Co., LTD.
*⁵“Zinc Oxide No. 2” manufactured by SAKAI CHEMICAL INDUSTRY CO., LTD.
*⁶“NOCCELER DM” manufactured by OUCHISHINKO CHEMICAL INDUSTRIAL CO., LTD.
*⁷“NOCCELER TS” manufactured by OUCHI SHINKO CHEMICAL INDUSTRIAL CO., LTD.
*⁸“NOCCELER TT” manufactured by OUCHI SHINKO CHEMICAL INDUSTRIAL CO., LTD.
*⁹“NOCCELER TRA” manufactured by OUCHI SHINKO CHEMICAL INDUSTRIAL CO., LTD.

TABLE 7

| | Comparative | Comparative | | Comparative | Comparative | |
|---|---|---|---|---|---|---|
| | Example 11 | Example 12 | Example 9 | Example 13 | Example 14 | Example 10 |
| electrical-resistance | | 30 | | | 30 | |
| adjusting agent of | | | | | | |
| Comparative Example 1 | | | | | | |
| electrical-resistance | | | 30 | | | 30 |
| adjusting agent of | | | | | | |
| Example 1 | | | | | | |
| ethylene-propylene | 100 | 70 | 70 | | | |
| rubber*¹ | | | | | | |
| chloroprene rubber*² | | | | 100 | 70 | 70 |
| stearic acid | 1 | 1 | 1 | 1 | 1 | 1 |
| precipitated calcium | 30 | 30 | 30 | 30 | 30 | 30 |
| carbonate*³ | | | | | | |
| magnesium oxide #150 | | | | 4 | 4 | 4 |
| 4,4′-thio-bis(6-tert-butyl-m- | 0.5 | 0.5 | 0.5 | 0.5 | 0.5 | 0.5 |
| cresol)*⁴ | | | | | | |
| zinc oxide*⁵ | 5 | 5 | 5 | 5 | 5 | 5 |
| naphthenic process oil*⁶ | 10 | 10 | 10 | | | |
| di-2-benzothiazolyl | 1 | 1 | 1 | | | |
| disulfide*⁷ | | | | | | |
| tetramethylthiuram | 0.3 | 0.3 | 0.3 | 0.5 | 0.5 | 0.5 |
| disulfide*⁸ | | | | | | |
| dipentamethylenethiuram | 0.5 | 0.5 | 0.5 | | | |
| tetrasulfide*⁹ | | | | | | |
| sulfur | 1.5 | 1.5 | 1.5 | | | |
| ethylene thiourea | | | | 1 | 1 | 1 |
| total amount | 149.8 | 149.8 | 149.8 | 142 | 142 | 142 |

Unit: part(s) by weight
*¹“JSR EP24” manufactured by JSR Corporation
*²“Showa Denko Chloroprene WXJ” manufactured by Showa Denko K.K.
*³“Silver-W” manufactured by SHIRAISHI CALCIUM KAISHA, LTD.
*⁴“ANTAGE CRYSTAL” manufactured by Kawaguchi Chemical Industry Co., LTD.
*⁵“Zinc Oxide No. 2” manufactured by SAKAI CHEMICAL INDUSTRY CO., LTD.
*⁶softener “SUNTHENE 415” manufactured by JAPAN SUN OIL COMPANY, LTD.
*⁷“NOCCELER DM” manufactured by OUCHI SHINKO CHEMICAL INDUSTRIAL CO., LTD.
*⁸“NOCCELER TT” manufactured by OUCHI SHINKO CHEMICAL INDUSTRIAL CO., LTD.
*⁹“NOCCELER TRA” manufactured by OUCHI SHINKO CHEMICAL INDUSTRIAL CO., LTD.

In accordance with the above method, the minimum viscosity, hardness, and volume resistivity of each of the rubber sheets obtained by the blends of Tables 6 and 7 were measured in the same manner as in Examples 2 to 6 and Comparative Examples 2 to 6, except that the measurement temperature of the minimum viscosity was changed to 125° C.

The results are shown in Tables 8 and 9.

TABLE 8

| | Comparative | Comparative | | Comparative | Comparative | |
|---|---|---|---|---|---|---|
| | Example 7 | Example 8 | Example 7 | Example 9 | Example 10 | Example 8 |
| minimum | 27 | 32 | 24 | 32 | 36 | 27 |
| viscosity | | | | | | |
| (Vm) | | | | | | |
| hardness | 53 | 54 | 53 | 49 | 49 | 46 |
| (JIS A) | | | | | | |
| volume | Over Range | 1.7 × 10⁸ | 1.3 × 10⁸ | 8.8 × 10⁹ | 3.4 × 10⁸ | 4.2 × 10⁸ |
| resistivity | | | | | | |
| (Ω · cm)*¹ | | | | | | |

*¹Measuring range is up to 1 × 10¹⁴.

TABLE 9

| | Comparative | Comparative | | Comparative | Comparative | |
|---|---|---|---|---|---|---|
| | Example 11 | Example 12 | Example 9 | Example 13 | Example 14 | Example 10 |
| minimum | 25 | 19 | 17 | 36 | 36 | 26 |
| viscosity | | | | | | |
| (Vm) | | | | | | |
| hardness | 52 | 52 | 52 | 57 | 56 | 55 |
| (JIS A) | | | | | | |
| volume | Over Range | 8.8 × 10⁹ | 1.7 × 10⁹ | 1.0 × 10¹¹ | 2.6 × 10⁸ | 1.3 × 10⁸ |
| resistivity | | | | | | |
| (Ω · cm)*¹ | | | | | | |

*¹Measuring range is up to 1 × 10¹⁴.

As shown in Tables 8 and 9, the composition obtained by blending the polyether electrical-resistance adjusting agent of the present invention and the rubber has improved processability, and allows the electrical resistance of a molded body obtained from the composition to lower. Furthermore, in some cases, the hardness of the molded body can be reduced.

### Example 11 and Comparative Examples 15 to 16

Materials with the blend shown in Table 10 were kneaded with a kneader and an open roll (kneading temperature: 160° C.). After performing pressurized pressing for 3 minutes at a temperature of 200° C., cooling and pressurized pressing for 1 minute was performed to obtain sheet-like molded bodies having a thickness of 2 mm.

The properties of each of the obtained molded bodies were evaluated as follows, and the results are shown in Table 10.

### <Durometer Type-D Hardness (Shore D)>

ABLER type-D durometer manufactured by Kobunshi Keiki Co., Ltd. was used to measure the hardness of the molded body in accordance with ASTM D2240,

### <Volume Resistivity>

The molded sheet was conditioned under an environment of a temperature of 23° C. and a relative humidity (RH) of 50%. Then, 4329A HIGH RESISTANCE METER and 16008A RESISTIVITY CELL manufactured by HEWLETT PACKARD were used to measure the resistance value of the molded sheet at an application of a voltage of 500 V in accordance with JIS K6271, and the volume resistivity was determined based on the following equation.

ρ (Volume resistivity)=(Cross-sectional area of molded body/Thickness of molded body)×Measured value

TABLE 10

| | | Compar- | Compar- | |
|---|---|---|---|---|
| | | ative | ative | |
| | | Exam- | Exam- | Exam- |
| | | ple 15 | ple 16 | ple 11 |
| component*¹ | ABS resin*² | 100 | 70 | 70 |
| | electrical-resistance | | 30 | |
| | adjusting agent of | | | |
| | Comparative Example 1 | | | |
| | electrical-resistance | | | 30 |
| | adjusting agent of | | | |
| | Example 1 | | | |
| | total amount | 100 | 100 | 100 |
| property | hardness | 81 | 67 | 65 |
| | (SHORE D) | | | |
| | volume resistivity | 2.7 × | 3.1 × | 4.2 × |
| | (Ω · cm) | 10¹⁶ | 10⁹ | 10⁹ |

*¹Unit: parts by weight
*²“EX18A” manufactured by UMG ABS, LTD.

As shown in Table 10, the composition obtained by blending the polyether electrical-resistance adjusting agent of the present invention and the resin allows the electrical resistance of a molded body obtained from the composition to lower and the hardness of the molded body to reduce.

### INDUSTRIAL APPLICABILITY

By blending the polyether electrical-resistance adjusting agent of the present invention with a rubber to prepare a composition, the processability of the composition can be improved, and the electrical resistance of a molded body obtained from the composition can be adjusted. Moreover, by blending the polyether electrical-resistance adjusting agent of the present invention with a resin to prepare a composition, the electrical resistance of a molded body obtained from the composition can be adjusted, and the hardness of the molded body can be reduced. Therefore, the polyether electrical-resistance adjusting agent of the present invention is industrially useful.

1. A polyether electrical-resistance adjusting agent, comprising a polymer that contains 10 to 60 mol % of a structural unit derived from an epihalohydrin (a), 30 to 89 mol % of a structural unit derived from an alkylene oxide (b), and 1 to 15 mol % of a structural unit derived from an ethylenically unsaturated group-containing monomer (c), and that has a weight-average molecular weight of 1,300,000 or less.

2. The polyether electrical-resistance adjusting agent according to claim 1, wherein the structural unit derived from the epihalohydrin (a) is a structural unit derived from at least one selected from epichlorohydrin and epibromohydrin.

3. The polyether electrical-resistance adjusting agent according to claim 1, wherein the structural unit derived from the alkylene oxide (b) is a structural unit derived from at least one selected from ethylene oxide, propylene oxide and butylene oxide.

4. The polyether electrical-resistance adjusting agent according to claim 1, wherein the structural unit derived from the ethylenically unsaturated group-containing monomer (c) is a structural unit derived from glycidyl methacrylate or allyl glycidyl ether.

5. An electrical-resistance adjusting agent-containing composition comprising the polyether electrical-resistance adjusting agent according to claim 1 and at least one selected from a rubber and a resin.

6. The electrical-resistance adjusting agent-containing composition according to claim 5, wherein the polyether electrical-resistance adjusting agent is contained in an amount of 120 parts by weight or less based on 100 parts by weight of a total amount of the rubber and the resin.

7. The electrical-resistance adjusting agent-containing composition according to claim 5, wherein the composition does not contain a conducting agent other than the polyether electrical-resistance adjusting agent, or when the composition contains a conducting agent other than the polyether electrical-resistance adjusting agent, a content of the conducting agent is 2 parts by weight or less based on 100 parts by weight of the polyether electrical-resistance adjusting agent.

8. A molded body formed by molding the electrical-resistance adjusting agent-containing composition according to claim 5.
